(19) United States
(12) Patent Application Publication
(10) Pub. No.: US 2024/0041019 A1
(43) Pub. Date: Feb. 8, 2024

(54) UNI-DIRECTIONAL ENTRANCE TUBE FOR RODENT TRAP

(71) Applicant: Kness Mfg. Co., Inc., Albia, IA (US)

(72) Inventor: Daniel L. Crew, Centerville, IA (US)

(73) Assignee: Kness Mfg. Co., Inc., Albia, IA (US)

(21) Appl. No.: 17/881,722

(22) Filed: Aug. 5, 2022

(51) Int. Cl. A01M 23/08; A01M 23/06; A01M 23/18

(52) U.S. Cl. CPC A01M 23/08; A01M 23/06; A01M 23/18; A01M 2200/00

(57) ABSTRACT

A uni-directional entrance tube for a rodent trap having opposite side walls, each of the first and second side walls including a ramp pivot, a ramp having an entrance end and a trap compartment end between the first and second side walls, the ramp pivotable about a hinge pin having first and second ends. The hinge pin is located between the entrance end and the trap compartment end and the first and second ends rotate within the ramp pivots in the first and second side walls. A counter weight is on an underside of the entrance end of the ramp and held in place by a tab extending downwardly from the entrance end of the ramp. A floor having an impact bump extending upwardly from the ramp is configured to shorten the throw of the ramp without reducing the overall height of the rodent trap.

### BACKGROUND

The present invention relates to a tilt ramp rodent trap. A tilt ramp rodent trap typically includes a box which encloses a trap compartment. A mouse hole typically provides entrance into the trap compartment. The mouse hole leads to a tube having a tube entrance opening adjacent the mouse hole and a tube exit opening leading into the trap compartment. Within the tube is a tilt tramp that pivots about a ramp or pin axis and has an entrance end and an exit end. A counter weight may be provided on the entrance end to bias the tilt ramp open to the mouse hole and closed to the trap compartment. A flap may be pivoted about a pivot pin and rests by gravity on the entrance end of tilt ramp.

When a mouse typically enters into the mouse hole, the mouse proceeds up the ramp, and when the mouse passes a point on the ramp the weight of the mouse tilts the ramp downwardly. At the same time the flap pivots upwardly in response to frictional engagement with the end of tilt ramp. When the mouse enters the trap compartment, the weight falls to the floor of the tunnel tilting the ramp such that it is closed to the mouse now trapped within the trap compartment. Repeated impact of the weight against the tunnel floor can fatigue the tabs holding the weight, and leads to eventual failure of the tabs to hold the weight in place. The ramp then is able to rotate freely and may not trap the mouse or other small rodent within the trap.

### SUMMARY

One aspect of the present disclosure includes a uni-directional entrance tube for a rodent trap having opposite side walls, each of the first and second side walls including a ramp pivot, a ramp having an entrance end and a trap compartment end between the first and second side walls, the ramp pivotable about a hinge pin having first and second ends. The hinge pin is located between the entrance end and the trap compartment end and the first and second ends rotate within the ramp pivots in the first and second side walls. A counter weight is on an underside of the entrance end of the ramp and held in place by a tab extending downwardly from the entrance end of the ramp. A floor having an impact bump extending upwardly from the ramp is configured to shorten the throw of the ramp without reducing the overall height of the rodent trap.

Another aspect of the present disclosure includes a rodent trap having a box enclosing a trap compartment and having a mouse opening providing access into the trap compartment, the box having a floor, an elongated tube within the trap compartment, the tube having first and second opposite side walls and a bottom wall, an open entrance end corresponding with the mouse opening and an open exit end in communication with the trap compartment, an elongated tilt ramp within the tube having an entrance end adjacent the mouse opening of the box and having an exit end adjacent the open exit opening of the tube, a ramp hinge pivotally mounting the tilt ramp within the tube for tilting movement about a hinge axis from a first position wherein the entrance end is adjacent the bottom wall of the elongated tube adjacent the mouse opening and the exit end is elevated above the entrance end such that access to the elongated tube is restricted from the trap compartment, to a second position wherein the exit end is lowered from the first position such that access to the trap compartment is allowed from the tilt ramp, a counter weight connected to an underside of the entrance end of the tilt ramp and biasing the tilt ramp to the first position, the counter weight held in place by a tab extending downwardly from the entrance end of the ramp, the ramp hinge comprising a ramp hinge pin having a first pin end pivotally mounted within the receptacle of the first boss and having a second pin end pivotally mounted within the receptacle of the second boss, whereby the pivotal movement of the first and second pin ends within the receptacles of the first and second bosses reduces the frictional force resisting tilting movement of the tilt ramp in response to the weight of the mouse, wherein the bottom wall of the elongated tube further comprises an impact bump extending upwardly toward the entrance end of the ramp, the impact bump configured to shorten the throw of the ramp without reducing the overall height of the rodent trap.

Yet another aspect of the present disclosure includes a method for using a tilt ramp trap having a box enclosing a trap compartment; a first mouse opening, an entrance tube within the trap compartment and having opposite side walls and a bottom wall, a first open end in communication with the first mouse opening and a second open end in communication with the trap compartment. The tilt ramp trap includes an elongated tilt ramp within the tube having first and second opposite side walls, and an entrance end adjacent the mouse opening of the box and an exit end adjacent the exit opening of the tube. A ramp hinge pivotally mounts the tilt ramp within the tube for tilting movement about a hinge axis from a first position wherein the entrance end is adjacent the bottom wall of the entrance tube adjacent the mouse opening and the exit end is elevated above the entrance end, to a second position wherein the exit end is lowered from the first position. A counter weight is connected to the tilt ramp and held in place with a plurality of tabs extending downwardly from the ramp and biasing the tilt ramp to the first position. The method includes rotating the first and second opposite ends of a hinge pin comprising part of the ramp hinge within spaced apart receptacles of first and second bosses, respectively, the first and second bosses being mounted to the opposite sidewalls of the tube so as to reduce the frictional forces required to tilt the tilt ramp from the first to the second position in response to the weight of the mouse, engaging the entrance end of the tilt ramp with a pivotally mounted flap and pivoting the flap about a flap axis from an open position to a closed position in response to movement of the tilt ramp from the first position to the second position, and reducing the throw of the ramp by integrating impact bumps into the bottom wall of the entrance tube such that the ramp does not rotate fully when the counter weight biases the ramp from the second position back to the first position.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of the lightweight responsive tilt ramp rodent trap of the present invention.

FIG. 2 is a perspective view showing the lid of the trap in its open position.

FIG. 3 is a sectional view taken along line 3-3 of FIG. 1 and showing mice entering the trap.

FIG. 4 is a view similar to FIG. 3, but showing the tilt ramps in their normal position without mice present.

FIG. 5 is an enlarged detail exploded perspective view showing the method of attachment of the tilt ramp and the hinged flap to the tube of the present invention.

FIG. 6 is a sectional view taken along lines 6-6 of FIG. 1.

### DETAILED DESCRIPTION

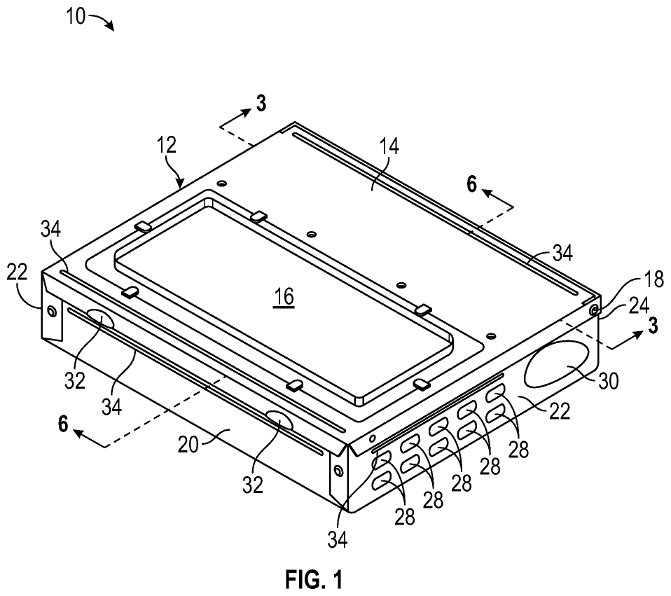

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

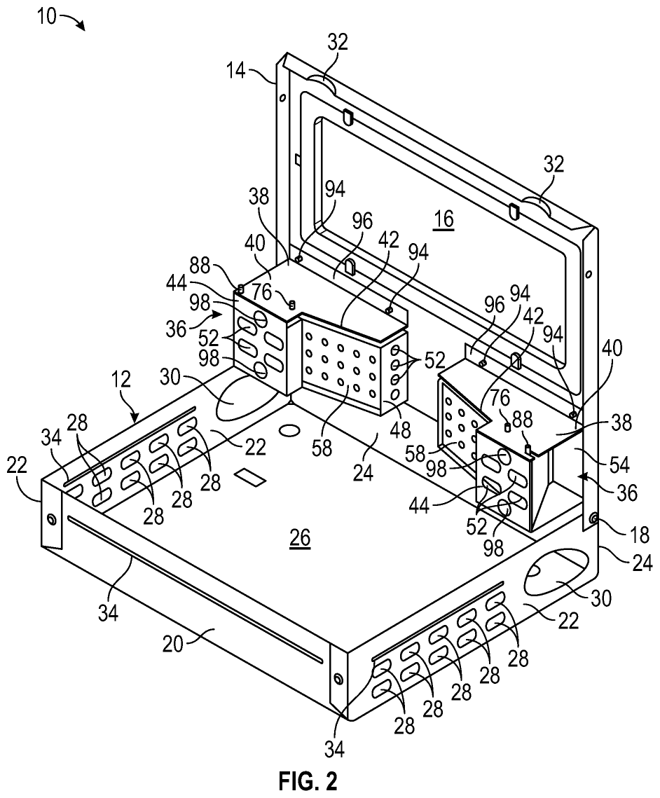

Referring to the drawings the numeral 10 generally refers to the trap of the present invention. Trap 10 includes a box 12, typically having a lid 14 with a transparent window 16 therein. The lid may be hinged about a lid hinge 18 to a back wall 24 of box 12. Box 12 also includes a front wall 20 and opposite end walls 22. A bottom wall 26 is also provided in box 12. Opposite end walls 22 are each provided with a plurality of ventilation openings 28, and each end wall 22 includes a mouse opening 30. The lid 14 may further include one or more lift tabs 32, as shown in FIG. 1 a pair of lift tabs 32 at its front edge for permitting an operator to grasp the lid and tilt it upwardly from the closed position shown in FIG. 1 to the open position shown in FIG. 2. End walls 22, front wall 20, rear wall 24, and lid 14 may all include elongated reinforcing ribs 34 which strengthen these walls against bending.

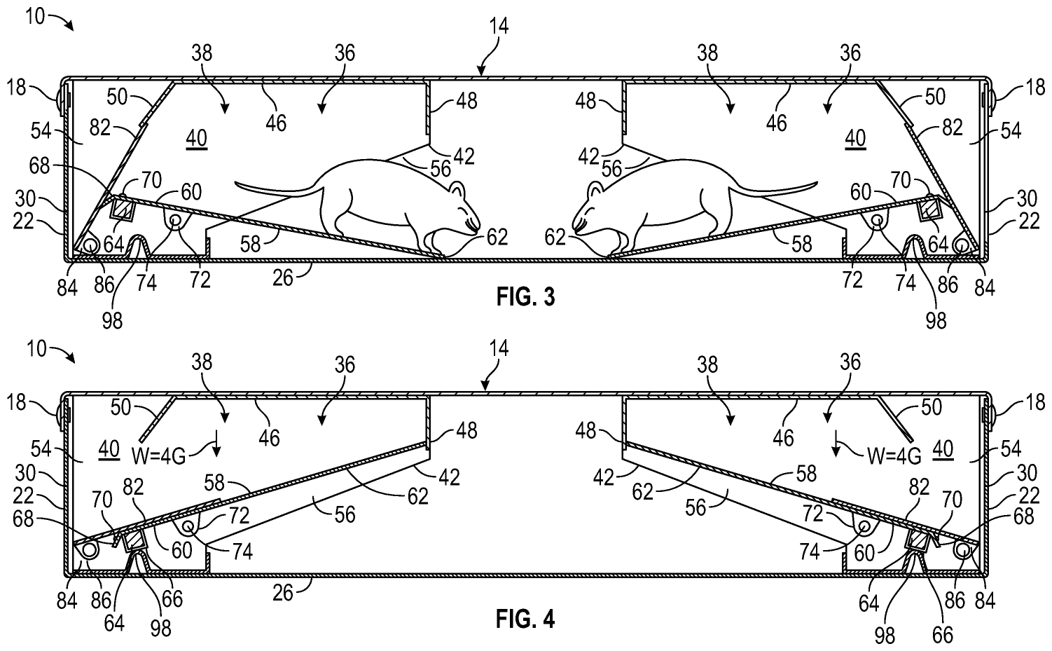

Looking at FIG. 2, attached to the under surface of lid 14 are two entrance tubes 36 each of which include opposite side walls 38. Side walls 38 each include a rectangular portion 40 and an angled lowered edge 42 which extends upwardly from the rectangular portion 40. Each tube 36 also includes a bottom wall 44 and a top wall 46. As shown in FIG. 3, top wall 46 is typically provided with a vertical flange 48 at its inner end and an angled flange 50 adjacent its outer end. Vent holes 52 are provided in vertical flange 48.

Each tube 36 includes an inlet opening 54 which is adapted to register with the mouse opening 30 when the lid 14 is closed so as to allow a mouse to enter the tube up a tilt ramp 58. Each tube is also provided with an outlet opening 56 that leads to the interior of the trap.

Mounted within each of the tubes 36 is the tilt ramp 58. Tilt ramp 58 includes an inlet end 60 and an outlet end 62. A counter weight 64 is attached to the inlet and 60 of the tilt ramp 58 by means of wrapped fingers 66 which extend around the counter weight and attach it to the tilt ramp 58. In addition to the wrapped fingers 66 there are angled tabs 68 which extend outwardly at an inclined angle with respect to the top surface of the tilt ramp 58. In addition, the inlet end 60 is provided with a pair of upwardly convex cam surface or dimples 70. A pair of hinge gears 72 extend downwardly from the tilt ramp 58 and receive an elongated hinge pin 74.

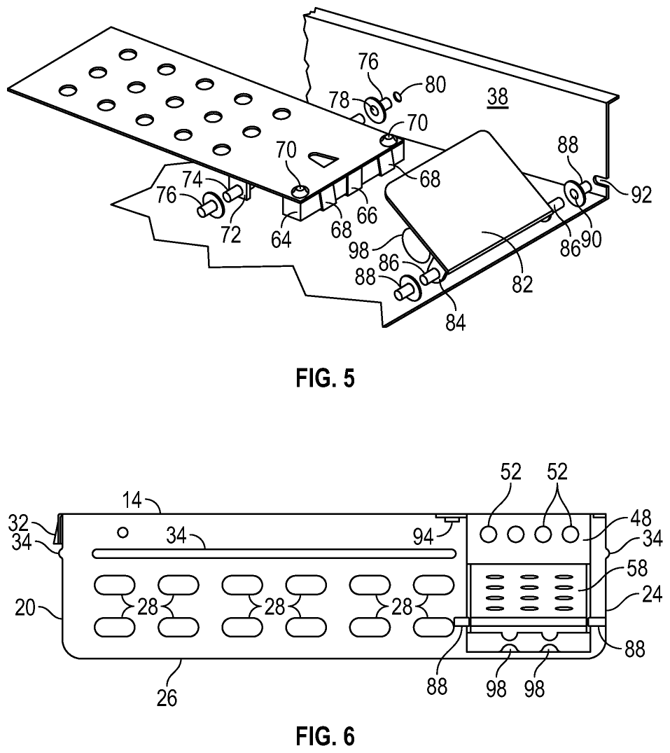

As can be seen in FIG. 5, the opposite ends of the hinge pin 74 fit within a boss 76 having a receptacle 78 for receiving the ends of the hinge pin 74. The bosses 76 are press fitted within boss receiving holes 80 in the opposite walls 38 of the tubes 36. The pins 74 are free to rotate within the receptacle 78, and this substantially reduces the friction necessary for the tilt ramp 58 to pivot about the hinge pins 74. As can be seen in FIG. 4, the counter weights 64 cause the tilt ramp 58 to be normally biased in the position shown in FIG. 4 when there are no mice present. In this position the tilt ramp 58 is inclined upwardly from its entrance end 60 to its elevated exit end 62.

A tilt flap 82 includes a pair of ears 84 which receive a flap pin 86. The opposite ends of flap pin 86 extend into a pin receptacle 90 of boss 88. Bosses 88 are press fitted into the slots 92. As a result the tilt flap 82 is free to pivot about the pin 86 which rotates within the receptacles 90 of the bosses 88. As with the pin 72 and bosses 76, these bosses 88 contributes significantly to a reduction in the friction necessary to tilt flap 82 about the axis provided by flap pin 86.

Each tube 36 is attached to the lid 14 by means of rivets 94 which extend through flanges 96 of the side walls 38 of the tubes 36. Other convenient means of attachment may be used. The tilt ramps 58 and the tilt flaps 82, because they are attached to the tubes 36, move upwardly in unison with the tubes 36 when the lid is pivoted from its closed position shown in FIG. 1 to its open position shown in FIG. 2. In this open position the tubes 36 are out of registration with the mouse holes 30, and are outside the box 12. This permits cleaning of the trap and is a substantial advantage over prior art devices in that the trap can be easily and quickly cleaned.

In operation, the tilt ramps 58 are normally in the position shown in FIG. 4. In this position the tilt flaps 82 rest on the upper surface of the tilt ramp 58 so that together the tilt ramp 58 and the tilt flaps 82 provide an elongated ramp for a mouse to enter through mouse hole 30. When a mouse enters the trap the mouse is drawn instinctively to the upper closed area provided at the upper exit end 62 of the tilt ramp 58. Tilt ramp 58 is adapted to tilt from its upper position shown in FIG. 4 to its lower position in FIG. 3 when a weight of 4 grams is applied to the tilt ramp at a point 1 5/16th inches from the pivotal axis provided by pins 74. FIG. 4 illustrates that this weight w is 4 grams.

The ability of the tilt ramp 58 to pivot in response to 4 grams as opposed to 7 grams is enhanced by the counter weight 66, by the reduced friction of the pins 74 in bosses 76, by the reduced friction of pins 86 and bosses 88, and by a further reduction in friction between the flap 82 and the upper surface of the tilt ramp 58. Further friction reduction is facilitated by means of the dimples 70 which engaged the tilt flap 82 during the tilting motion thereby preventing the tilt flap 82 from frictionally engaging the upper surface of the tilt ramp 58. This reduces the friction during this initial motion. In addition, the angled tabs 68 engage the tilt flap 82 as shown in FIG. 3 during the latter portion of the tilting action. This further reduces the friction between the tilt ramp 58 and the tilt flap 82.

When the tilt ramp 58 tilts to its lower position shown in FIG. 3, the flanges or angled tabs 68 engage the tilt flap 82 and cause it to engage the angled flap 50 at the top of each tube 36. This provides a barrier to prevent the mouse from exiting the trap.

A glue board (not shown) may be placed on the floor 26 of the box 12 so as to capture the mice that have entered the trap.

An advantage of the reduced weight required to tilt the tilt ramp 58 from its upper most position shown in FIG. 4 to its lowered position in FIG. 3 is that infant mice can be captured in this trap as well as adult mice. Infant mice often have a weight which is on the order of 4 grams, and in prior devices this was not sufficient weight to tilt the tilt ramp when infant mice entered the trap. The present invention captures not only adult mice but infant mice as well.

When the mouse completes it travel across ramp 58 and into the interior of the trap 10, the counter weight 66 draws the entrance side of the ramp 58 downwardly, and rotates the tip 62 of the ramp 58 up such that it is ‘hidden’ behind downstanding wall 48. In this way, a mouse within the trap 10 cannot get back out through the entrance tubes 36. However, repeated impact of the weight on the floor 26 of the trap 10 or on a lower wall of the entrance tube 36 may fatigue and eventually fail the tabs 68 holding the weight in place.

A single impact bump 98 or more than one impact bumps 98 may be placed on the lower wall of the entrance tube 36 on either side of the ramp 58 where the counter weight 66 would impact a flat floor 26. In this way, the throw of the entrance end of the ramp 58 is reduced, the acceleration due to gravity of the weight is shortened, and the impact is reduced without needing to reduce the overall height of the trap 10 itself or the entrance tube 36. Further, by placing the bumps 98 at placed where they will only touch the weight and not the tabs 68 or the ramp 58, the counter weight 66 is supported by the bumps 98 at impact, and fatigue on the tabs 68 is effectively eliminated.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstances may suggest or render expedient without departing from the spirit or scope of the invention as further defined in the following claims.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A uni-directional entrance tube for a rodent trap comprising:
first and second opposite side walls, each of the first and second side walls including a ramp pivot;
a ramp having an entrance end and a trap compartment end disposed between the first and second side walls, the ramp pivotable about a hinge pin having first and second ends, the hinge pin located between the entrance end and the trap compartment end and the first and second ends rotate within the ramp pivots in the first and second side walls,
a counter weight on an underside of the entrance end of the ramp, the counter weight held in place by a tab extending downwardly from the entrance end of the ramp;
a floor having an impact bump extending upwardly from the ramp, the impact bump configured to shorten the throw of the ramp without reducing the overall height of the rodent trap.

2. The uni-directional entrance tube of claim 1, wherein the ramp further comprises at least two tabs to hold the counter weight in place.

3. The uni-directional entrance tube of claim 2, wherein the impact bump is configured to impact the counter weight between the at least two tabs of the ramp.

4. The uni-directional entrance tube of claim 3 further comprising a second impact bump.

5. The uni-directional entrance tube of claim 1, wherein the first and second ends of the hinge pin each rotate within a hinge boss press fit within the ramp pivot of each of the first and second wall.

6. The uni-directional entrance tube of claim 1, further comprising a tilt flap rotatable about a tilt flap pin disposed on a first end of the tilt flap, the tilt flap pin having first and second ends rotatably located within a tilt flap pivot within each of the first and second walls.

7. The uni-directional entrance tube of claim 1, wherein the uni-directional entrance tube is configured to be attached to a lid of the rodent trap.

8. The uni-directional entrance tube of claim 7, wherein the uni-directional entrance tube is a first uni-directional entrance tube, and further comprising a second uni-directional entrance tube attached to an opposite side of the lid of the rodent trap.

9. The uni-directional entrance tube of claim 8, wherein the rodent trap includes first and second mouse openings within first and second sidewalls, and an entrance end of each of the first and second uni-directional entrance tubes corresponds to the first and second mouse openings within the first and second sidewalls.

10. A rodent trap comprising:
a box enclosing a trap compartment and having a mouse opening providing access into the trap compartment, the box having a floor;
an elongated tube within the trap compartment, the tube having first and second opposite side walls and a bottom wall, an open entrance end corresponding with the mouse opening and an open exit end in communication with the trap compartment;
an elongated tilt ramp within the tube having an entrance end adjacent the mouse opening of the box and having an exit end adjacent the open exit opening of the tube;
a ramp hinge pivotally mounting the tilt ramp within the tube for tilting movement about a hinge axis from a first position wherein the entrance end is adjacent the bottom wall of the elongated tube adjacent the mouse opening and the exit end is elevated above the entrance end such that access to the elongated tube is restricted from the trap compartment, to a second position wherein the exit end is lowered from the first position such that access to the trap compartment is allowed from the tilt ramp;
a counter weight connected to an underside of the entrance end of the tilt ramp and biasing the tilt ramp to the first position, the counter weight held in place by a tab extending downwardly from the entrance end of the ramp;
the ramp hinge comprising a ramp hinge pin having a first pin end pivotally mounted within the receptacle of the first boss and having a second pin end pivotally mounted within the receptacle of the second boss, whereby the pivotal movement of the first and second pin ends within the receptacles of the first and second bosses reduces the frictional force resisting tilting movement of the tilt ramp in response to the weight of the mouse;
wherein the bottom wall of the elongated tube further comprises an impact bump extending upwardly toward the entrance end of the ramp, the impact bump configured to shorten the throw of the ramp without reducing the overall height of the rodent trap.

11. The rodent trap of claim 10, wherein the ramp further comprises at least two tabs to hold the counter weight in place.

12. The rodent trap of claim 11, further comprising a second impact bump.

13. The rodent trap of claim 12, wherein the impact bump and the second impact bump are each configured to impact the counter weight directly.

14. The rodent trap of claim 10, wherein the counter weight yields in response to the weight of a rodent adjacent the exit end of the tilt ramp to rotate the tilt ramp to move to the second position

15. The rodent trap of claim 10 further comprising a first boss having a boss receptacle mounted to the first side wall of the tube and a second boss having a boss receptacle mounted to the second side wall of the tube;

16. The rodent trap of claim 10 further comprising a flap mounted to the tube by a flap hinge and engaging the tilt ramp adjacent the entrance end of the tilt ramp, the flap being pivotal about the flap hinge from an open position permitting a mouse to enter the entrance end of the tube to a closed position closing off the entrance end of the tube in response to the movement of the tilt ramp from the first to the second position.

17. The rodent trap of claim 16 further comprising at least one dimple located between the tilt ramp and the flap for reducing the frictional force between the tilt ramp and the flap during movement of the flap from the open and closed positions in response to movement of the tilt ramp from the first to the second position.

18. The rodent trap of claim 10 wherein the elongated tube is attached to a cover of the rodent trap.

19. A method for using a tilt ramp trap comprising a box enclosing a trap compartment; a first mouse opening in the box; an entrance tube within the trap compartment, the entrance tube having opposite side walls and a bottom wall, a first open end in communication with the first mouse opening and a second open end in communication with the trap compartment; an elongated tilt ramp within the tube having first and second opposite side walls, an entrance end adjacent the mouse opening of the box and an exit end adjacent the exit opening of the tube; a ramp hinge pivotally mounting the tilt ramp within the tube for tilting movement about a hinge axis from a first position wherein the entrance end is adjacent the bottom wall of the entrance tube adjacent the mouse opening and the exit end is elevated above the entrance end, to a second position wherein the exit end is lowered from the first position; a counter weight connected to the tilt ramp and held in place with a plurality of tabs extending downwardly from the ramp and biasing the tilt ramp to the first position, the method comprising:
rotating the first and second opposite ends of a hinge pin comprising part of the ramp hinge within spaced apart receptacles of first and second bosses, respectively, the first and second bosses being mounted to the opposite sidewalls of the tube so as to reduce the frictional forces required to tilt the tilt ramp from the first to the second position in response to the weight of the mouse;
engaging the entrance end of the tilt ramp with a pivotally mounted flap and pivoting the flap about a flap axis from an open position to a closed position in response to movement of the tilt ramp from the first position to the second position; and
reducing the throw of the ramp by integrating impact bumps into the bottom wall of the entrance tube such that the ramp does not rotate fully when the counter weight biases the ramp from the second position back to the first position.

20. The method of claim 19, further comprising the step of:
placing at least one dimple between the tilt ramp and the flap so as to further reduce the frictional forces required to tilt the tilt ramp from the first position to the second position in response to the weight of the mouse.
